(19) United States
(12) Patent Application Publication
(10) Pub. No.: US 2002/0015585 A1
(43) Pub. Date: Feb. 7, 2002

(54) Multivariable compact electric heater

(75) Inventors: Myron Jensen, Harrisville, UT (US); Steve Nestel, Ogden, UT (US); Randy C. Jarrett, Mantua, UT (US); John L. Henrie, Ogden, UT (US); Sam Henry, Ogden, UT (US); Lorin Adkins, No. Ogden, UT (US); Bruce Barnes, Valencia, PA (US)

Correspondence Address: HOWREY SIMON ARNOLD & WHITE, ATTORNEYS AT LAW, 750 Bering Drive, Houston, TX, 77057-2198, US

(73) Assignee: Emerson Electric Company

(21) Appl. No.: 09/878,640

(22) Filed: Jun. 11, 2001

Related U.S. Application Data
(60) Provisional application No. 60/212,878, filed on Jun. 9, 2000.

(51) Int. Cl. H05B 3/82; F24H 1/10

(52) U.S. Cl. 392/485; 392/488; 392/500; 392/501

(57) ABSTRACT

A multivariable circulation heater. In one embodiment, the invention is a multivariable circulation heater comprising: (a) a heater having a bundle of configurable heating elements, a plurality of heating elements having selectable electrical terminations, wherein the heater may be configured for a plurality of heating capacity and/or power supply configurations by configuring the selectable electrical terminations; (b) a chamber having an insulated vessel for surrounding the bundle of configurable heating elements, wherein the vessel has a threaded screw plug opening and a plurality of bosses for adapting to inlet and outlet connections; (c) a screw plug adapted to screw into the threaded screw plug opening, the screw plug having two ends, wherein a first end is secured to the bundle of configurable heating elements and a second end is secured to the selectable electrical terminations.

### CROSS REFERENCE TO RELATED APPLICATIONS

This application claims the benefit of U.S. Provisional Application No. 60/212,878, filed Jun. 9, 2000. This Provisional Application is hereby incorporated herein by reference in its entirety.

### FIELD OF THE INVENTION

This invention relates generally to circulation heaters and more particularly, to compact variable circulation heaters.

### BACKGROUND OF THE INVENTION

Heating stagnant and circulating mediums, e.g., liquid, gas, steam, air, in containers, e.g., tanks, reservoirs, pipes, are common industrial practices for numerous reasons. Heating may be required to maintain a certain viscosity of heavy oils or resins that allow them to be readily pumped. Heating may also prevent crystalline precipitation or freezing during the process, or may simply facilitate the process itself.

An immersion heater represents one type of heater used to heat mediums. An immersion heater, such as a screw plug or flanged heater, has a protruding heating element, for insertion through a bore hole in a container wall, a base, for mounting to or within the bore, and electrical terminals for connecting to a power source. In this way, the heating elements extend within the container, the base seals the hole, and the electrical terminals for the heating elements are accessible outside the container wall.

Circulation heaters consist of a screw plug or flanged type immersion heater mounted in a thermally insulated heating chamber with input and output terminals. Circulation heaters are designed to efficiently heat flowing mediums. Circulation heaters must be capable of withstanding the high pressures and temperatures of the heated mediums.

The difficulty presented by field applications is that each application may call for different heating capacity, power supply connections (i.e., power, voltage, phase, current, number of circuits, etc.), pipe connections, and circulation heater dimensions. It would be of great utility to have a single design which could adapt to the widest number of applications.

The present invention is directed to overcoming, or at least reducing the effects of, one or more of the problems set forth above.

### SUMMARY OF THE INVENTION

A multivariable heater. In one embodiment, the invention is a multivariable heater comprising: (a) a heater having a bundle of configurable heating elements, a plurality of heating elements having selectable electrical terminations, wherein the heater may be configured for a plurality of heating capacity and/or power supply configurations by configuring the selectable electrical terminations; (b) a chamber having an insulated vessel for surrounding the bundle of configurable heating elements, wherein the vessel has a threaded screw plug opening and a plurality of bosses for adapting to inlet and outlet connections; (c) a screw plug adapted to screw into the threaded screw plug opening, the screw plug having two ends, wherein a first end is secured to the bundle of configurable heating elements and a second end is secured to the selectable electrical terminations.

### BRIEF DESCRIPTION OF THE DRAWINGS

The foregoing and other features and aspects of the present invention will be best understood with reference to the following detailed description of specific embodiments of the invention, when read in conjunction with the accompanying drawings, wherein:

1 FIG. 1 displays an exploded view of the adaptable circulation heater in accordance with the invention;

FIG. 2 displays an exploded view of a rotatable housing used in conjunction with an embodiment of the invention;

FIG. 3A displays a chamber with knock-outs for tapping input and output pipe connections in accordance with an embodiment of the invention; and

FIG. 3B displays a cross section of the chamber shown in FIG. 3A.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF EMBODIMENTS OF THE INVENTION

In the disclosure that follows, in the interest of clarity, not all features of actual implementations are described. It will of course be appreciated that in the development of any such actual implementation, as in any such project, numerous engineering and design decisions must be made to achieve the developers' specific goals and subgoals (e.g. compliance with mechanical and business-related constraints), which will vary from one implementation to another. Moreover, attention will necessarily be paid to proper engineering and design practices for the environment in question. It will be appreciated that such a development effort might be complex and time-consuming, but would nevertheless be a routine undertaking for those of skill in the art.

In accordance with the invention, FIG. 1 displays an exploded view of an adaptable circulation heater 100. Shown in FIG. 1 are four primary elements, chamber 105, heater 110, screw plug 115, and rotatable housing 155. As shown, chamber 105 comprises a vessel 120. Vessel 120 includes a plurality of bosses 125 for adapting to inlet and outlet connections, and a threaded screw plug opening 130. Heater 110 comprises a bundle of heating elements 135. At one end screw plug 115 comprises threaded end 140 for screwing into screw plug opening 130. Threaded end 140 is secured (e.g., welded) to the bundle of heating elements 135. The other end of screw plug 115 comprises a flange 145. Flange 145 secures selectable electrical terminations 150 (not visible in FIG. 1) for the bundle of heating elements 135. Affixed to flange 145 is rotatable housing 155.

For operation heater 110 is inserted into chamber 105. Heater 110 is sealed inside chamber 105 by screwing screw plug 115 into screw plug opening 130 of chamber 105, attaching inlet and outlet connections to a plurality of bosses 125, and sealing any unused bosses 125 with threaded plugs 165. Once sealed, the medium to be heated is injected into chamber 105 through the boss(es) 125 operating as the inlet. The medium is heated in accordance with the selected wiring configuration of electrical terminations 150 and control of power supplied through the wiring configuration to one or more heating elements 135. The heated medium is extracted from the chamber through boss(es) 125 operating as an outlet. Thermocouple 160 extends through the screwplug to assist in the maintenance of desirable temperature by providing feedback to a power supply controller (not shown).

Vessel 120 may be constructed of cast iron. A galvanized coating may be applied to the cast iron for water heating applications. Heating elements 135 may comprise, for example, INCOLOY® sheath heating elements welded to a 2.5 inch diameter steel screw plug.

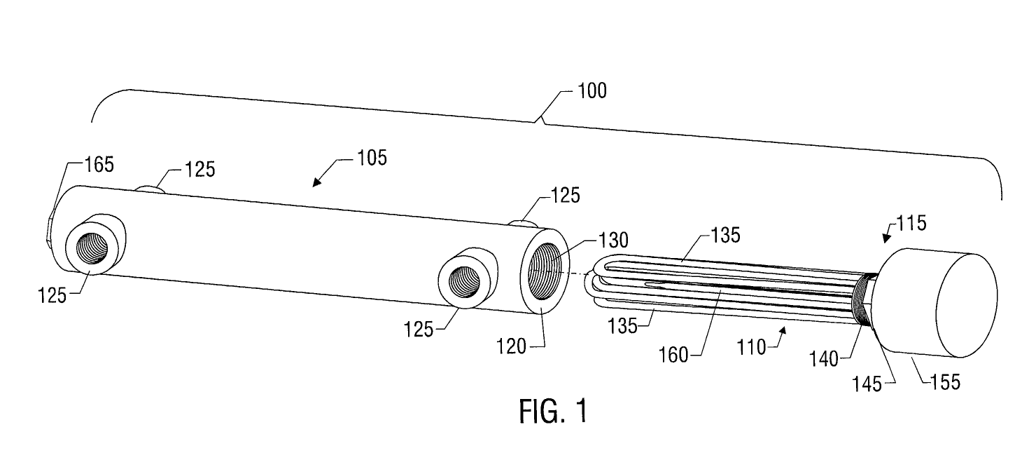

FIG. 2 displays an exploded view of an embodiment of heater 110 and screwplug 115 in greater detail. Commonly assigned U.S. Pat. No. 5,528,722, incorporated herein by reference, describes rotatable housing 155 and its operation in greater detail; therefore, only a brief description will be provided herein. Housing 155 includes base 200, mounting means 205, and cover 210. Mounting means 205 is secured to flange 145 by inserting screws 215 through central opening 220 of base 200 and holes 225 in mounting means 205, and screwing them into screw holes 230 in flange 145. The heads of screws 215 capture base plate 260 of base 200. Before tightening screws 215, base 200 can be rotated to align with incoming wiring. Tongue 235 on base 200 operates to minimize movement of incoming wiring with opening 240. Once internal wiring is complete, cover 210 slips over base 200. The heads of screws 245 secure cover 210 to base 200. Cover 210 can be removed by loosening, without removing, screws 245.

Also shown in FIG. 2 is the interface between screw plug 145 and heating element bundle 135. In the embodiment shown, heating elements comprise loops such that an electrical path is provided through the length of each of six looped heating elements in heating element bundle 135. The electrical path for each heating element loop extends through threaded end 140 and flange 145 of screw plug 115 to twelve selectable electrical terminations 150. FIG. 2 shows electrical insulation 250 surrounding wire 255 for each termination in the selectable electrical terminations 150.

The numerous power supply configurations made possible by selectable electrical terminations 150 and numerous heating capacity configurations made possible by the configurable bundle of heating elements 135 would be understood by one skilled in the art having the benefit of this disclosure. Moreover, specific configurations may also depend on the technical specifications of the heating elements and electrical terminations.

A multitude of power supply configurations for an embodiment of the invention are described in publicly available literature from Chromalox Product Service, 2150 N. Rulon White Blvd., Ogden, Utah 84404; phone number (800) 368-2493; website www.chromalox.com. More specifically, Literature ID (e.g., sales/service reference) No. PD449, 161-048381-701, dated January 2001, entitled “Installation, Operation and Renewal parts Identification” for “VersaTHERM” products describes the following product models: VTS-3180 (PCN Nos. 181075, 181083), VTS-3200 (PCN No. 181913), VTS-3240 (PCN Nos. 181921, 181930), and VTS-3400 (PCN No. 181948). The aforementioned literature is hereby incorporated herein by reference in its entirety.

Additional publicly available information is contained in datasheets for screw plug and circulation style VersaTHERM product heaters from Chromalox Product Service. More specifically, the circulation style heaters available from Chromalox include models NWHOSR-06-04P5-E1 (PCN Nos. 100108 & 100116), NWHOSR-06-005P-E1 (PCN No. 100124), NWHOSR-06-006P-E1 (PCN Nos. 100132 & 100140), NWHOSR-06-040P-E1 (PCN No. 100159), NWHSRG-06-018P-E1 (PCN Nos. 100010 & 100028), NWHSRG-06-020P-E1 (PCN No. 100036), NWHSRG-06-024P-E1 (PCN Nos. 100044 & 100079), and NWHSRG-06-040PE1 (PCN 100095). The aforementioned VersaTHERM product data sheet literature is hereby incorporated herein by reference in its entirety.

Employing the previously mentioned series of products, an embodiment having six selectable heating elements may be variably configured, for instance, for 120, 208, 240, or 480 Volt single phase power supply or 208, 240, or 480 Volt ti-phase power supply to provide, for instance, between 2 to 23 W/In² (0.5 to 10 W) for oil applications and between 2 to 80 W/In² (0.5 to 40 W) for water applications.

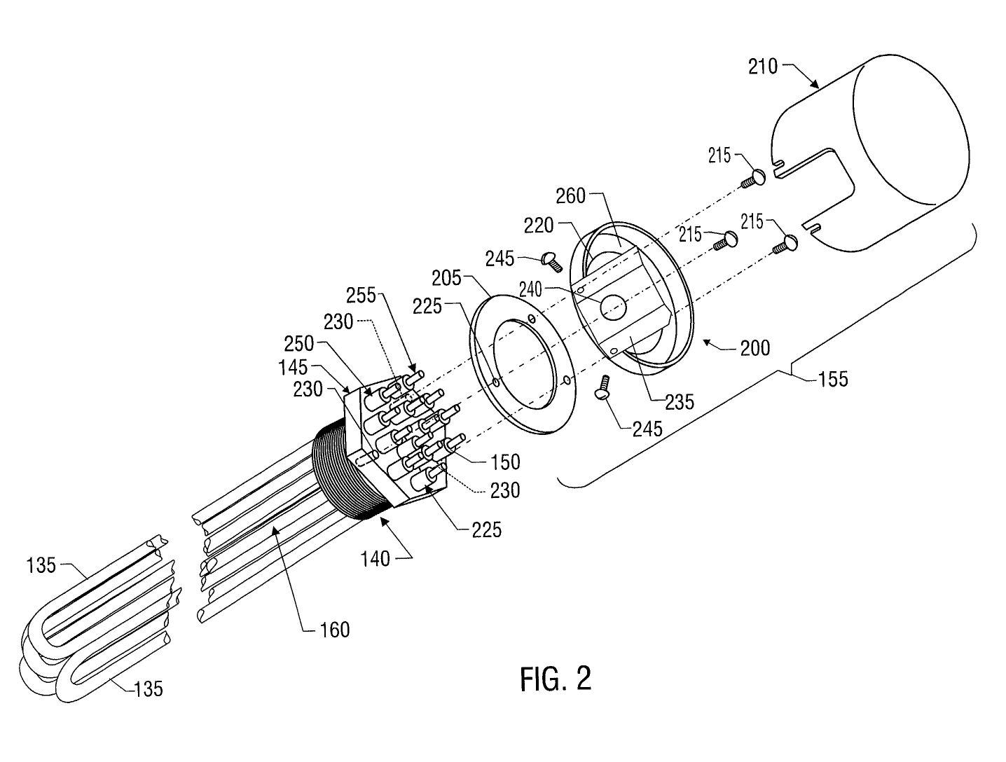

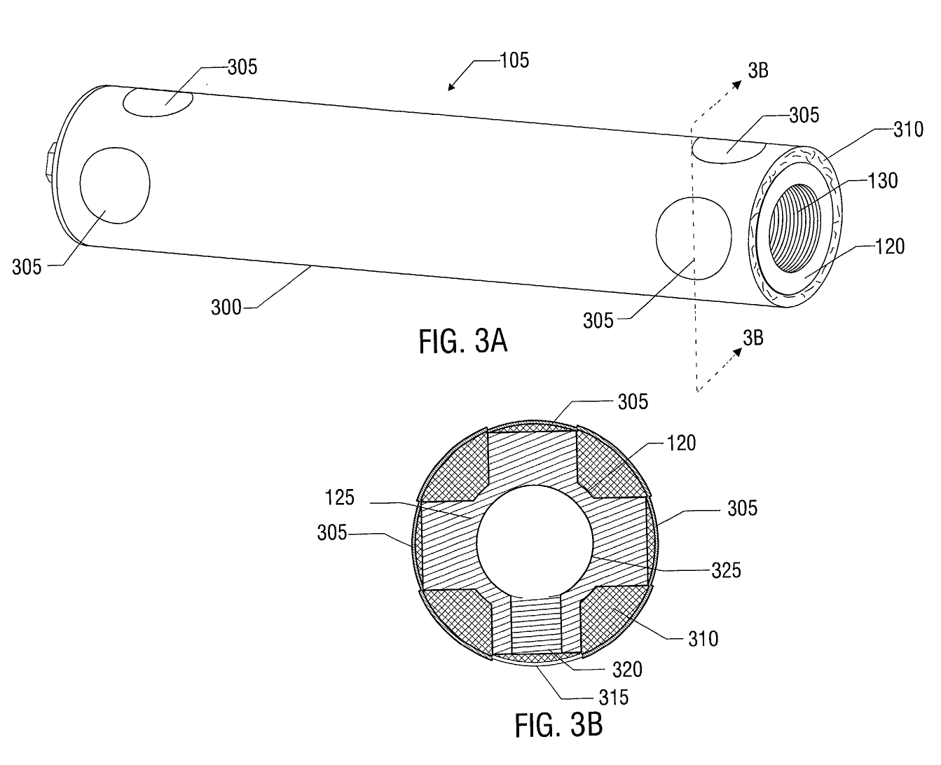

Referring now to FIG. 3A, a second embodiment of a multivariable circulation heater is shown. Chamber 105 is shown with vessel 120 surrounded by insulation 310 (e.g. fiberglass), which is surrounded by shell 310 (e.g. sheet metal) having a plurality of knock-outs 305 coinciding with the location of a plurality of bosses 125 on vessel 120. In the event knock out 300 is a necessary location for an inlet or outlet, knock-out 305 is removed and a hole is drilled and tapped through insulation 310 and boss 125 to provide the necessary inlet or outlet connection.

A cross-section of chamber 105 appears in FIG. 3B. Vessel opening 325 in vessel 120 opens to input or output through threaded inlet/outlet 320 and knock-out opening 315. Bosses 125 may be drilled, tapped, and sealed with threaded plugs before applying insulation 310 so that in the field one need only remove the knock-out, clear some insulation, and remove a threaded plug to avoid the additional steps of drilling and tapping boss 125. In the event the wall thickness is thick enough to satisfy pressure specifications and provide adequate threading for inlet/outlet connection a boss may not be necessary. This would allow more knock-outs and greater versatility in field adaptations.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. For instance, the screw plug need not have a flange or adapt to a rotatable housing. In another example, the heater may be a flange style heater rather than a screw plug style heater. Accordingly, the protection sought herein is as set forth in the claims below.

What is claimed is:

1. A multivariable heater comprising:
(a) a heater having a bundle of configurable heating elements, a plurality of heating elements having selectable electrical terminations, wherein the heater may be configured for a plurality of heating capacity and/or power supply configurations by configuring the selectable electrical terminations.

2. The multivariable heater of claim 1 further comprising:
(b) a chamber having an insulated vessel for surrounding the bundle of configurable heating elements, wherein the vessel has a threaded screw plug opening and a plurality of bosses for adapting to inlet and outlet connections.

3. The multivariable heater of claim 2 further comprising:
(c) a screw plug adapted to screw into the threaded screw plug opening, the screw plug having two ends, wherein a first end is secured to the bundle of configurable heating elements and a second end is secured to the selectable electrical terminations.

4. The multivariable heater of claim 2, the chamber further comprising a shell surrounding the insulated vessel, wherein the shell has a plurality of knock-outs coinciding with the location of the plurality of bosses.

5. A multivariable heater comprising:
(a) a heater having a bundle of configurable heating elements, a plurality of heating elements having selectable electrical terminations, wherein the heater may be configured for a plurality of heating capacity and/or power supply configurations by configuring the selectable electrical terminations; and
(b) a vessel for surrounding the bundle of configurable heating elements, wherein the vessel has a plurality of bosses for adapting to inlet and outlet connections.

6. The multivariable heater of claim 3, further comprising:
(c) a chamber comprising a shell surrounding the vessel, wherein the shell has a plurality of knock-outs coinciding with the location of the plurality of bosses.

7. A circulation heater vessel having a plurality of bosses for adapting the vessel to inlet and outlet connections.

8. The circulation heater vessel of claim 5, further comprising a shell surrounding the vessel, wherein the shell has a plurality of knock-outs coinciding with the location of the plurality of bosses.

9. A circulation heater chamber comprising a shell surrounding a vessel, wherein the shell has a plurality of knock-outs for adapting the chamber to inlet and outlet connections.
